(19) United States
(12) Patent Application Publication
(10) Pub. No.: US 2018/0263210 A1
(43) Pub. Date: Sep. 20, 2018

(54) LITTER FOR USE IN ANIMAL KEEPING

(71) Applicant: Catural GmbH, Mannheim (DE)

(72) Inventor: Immanuel Josef EHRLER, Mannheim (DE)

(73) Assignee: Catural GmbH, Mannheim (DE)

(21) Appl. No.: 15/762,583

(22) PCT Filed: Oct. 10, 2016
(86) PCT No.: PCT/EP2016/001676

§ 371 Date: Mar. 23, 2018

(30) Foreign Application Priority Data
Oct. 22, 2015 (EP) 15003033.6

(51) Int. Cl. A01K 1/015

(52) U.S. Cl. CPC A01K 1/0155

(57) ABSTRACT

The present invention relates to a litter for use in animal keeping, consisting of 10 to 80% by weight of cellulosic substance which is selected from at least one component of the group consisting of wood meal, bran, hulls and bran, cereal hull and cereal husk, 10 to 70% by weight of cereal flour and 0.1 to 4% by weight of gel former, based on the total weight of the litter, where the above components always amount to 100% by weight, where the cellulosic substance is present in the form of particles with a particle size of from 0.2 to 6 mm.

The present invention relates to a litter for use in animal keeping, consisting of 10 to 80% by weight of cellulosic substance which is selected from at least one component of the group consisting of wood meal, bran, hulls and bran, cereal hull and cereal husk, 10 to 70% by weight of cereal flour and 0.1 to 4% by weight of gel former, based on the total weight of the litter, where the above components always amount to 100% by weight, where the cellulosic substance is present in the form of particles with a particle size of from 0.2 to 6 mm.

Litter is a material that is used in animal keeping for covering the ground in animal houses and cages and for taking up the animals' excretions. Materials being used are organic and inorganic materials, in most cases inexpensive agricultural or industrial by-products or cheap raw materials. The traditional and widely used materials include straw, wood shavings from hard wood species (such as beech or aspen) and soft wood species (such as pine and cedars), and also sand.

An economical use of the litter is ensured when, once the litter layer has been wetted by the animal's body fluid, the latter does not trickle across the entire litter layer, which would require renewal of the entire litter layer. The upper portions which come into contact with the fluid stick together, so that clusters or sheet-like soft lumps are formed at the top of the litter layer, which clusters or lumps, which are now the top layer, can be removed from the litter layer using a small shovel or fork, without adversely affecting the underlying layers. The soiling caused by the body fluid is therefore limited to a small area, while the remainder remains unaffected. This effect is achieved by the litter itself having cluster-forming properties.

A litter which has this cluster-forming property and is additionally biodegradable is particularly advantageous, because it can be discharged into the sewage system.

A known litter which is biodegradable and based on renewable raw materials consists in most cases of wood meals and gel formers. Wood meals act as separating and binding agents in a litter, and gel formers act as fluid absorbers and cluster solidifiers. A high proportion of gel former, however, results in disadvantageous agglutinations of the litter on animal hairs, so that the agglutinated litter can be transferred by the animal into the animal keeper's dwelling, thereby causing soiling.

DE 601 14 237 describes a litter without gel former, which litter is biodegradable and based on renewable raw materials and which litter comprises wood meal and cereal flour. While such a litter shows a very small amount of agglutination, the products do not harden and therefore display insufficient cluster stability.

In the light of these known litters, it is desirable to provide a biodegradable litter which is based on renewable raw materials and which does not have the abovementioned disadvantageous properties.

It is therefore an object of the present invention to provide a litter which is biodegradable, consists of renewable raw materials, makes possible the formation of clusters with a high cluster stability and causes little agglutination on animal hairs.

This object is achieved by the embodiments characterized in the claims.

The inventive litter for use in animal keeping consists of 10 to 80% by weight of cellulosic substance which is selected from at least one component of the group consisting of wood meal, bran, hulls and bran, cereal hull and cereal husk, 10 to 70% by weight of cereal flour and 0.1 to 4% by weight of gel former, based on the total weight of the litter, where the above components always amount to 100% by weight, where the cellulosic substance is present in the form of particles with a particle size of from 0.2 to 6 mm.

The cellulosic substance accounts for 10 to 80% by weight, preferably 20 to 70% by weight, especially preferably 30 to 65% by weight of the litter. If the cellulosic substance accounts for less than 10% by weight, a sufficient urine uptake of the litter cannot be ensured. If, however, the cellulosic substance accounts for more than 80% by weight, cluster formation is insufficient, whereby the urine trickles into the lower layers and the litter cannot be used in an economical fashion.

The cellulosic substance is at least one component of the group consisting of wood meal, bran, hulls and bran, cereal hull and cereal husk. It is preferred to use bran as the cellulosic substance. Bran consists of cereal hulls, an aleuron layer and a germ. Instead of the bran, or in combination with the bran, it is also possible to employ hulls and bran, such as, for example, spelt hull.

In accordance with the invention, the particles of the cellulosic substance have a size of from 0.2 to 6 mm, particularly preferably a size of from 0.3 mm to 1.5 mm. If the size of the particles is less than 0.2 mm, this results in the formation of dust, which is disadvantageous. Particles with a size of more than 6 mm, in turn, are more difficult to process and additionally are capable of absorbing less moisture as a result of the surface area being reduced in comparison with smaller particles.

The cereal flour of the litter according to the invention is not particularly limited as long as it is untreated cereal flour, including commercially available types of flour. It may be used in the form of a pre-gelatinized flour. Pre-gelatinized flour is an extruded flour or else a chemically digested flour. A water/flour mixture is uniformly extruded from a shaping aperture in the extruder under high pressure and high temperature, so that the starch in the pre-gelatinized flour is thermally digested by the extrusion process. As the result of this thermal digestion or as the result of corresponding chemical starch digestion processes, pre-gelatinized flours have a higher water-binding capacity than untreated flours. The pre-gelatinized flour may be prepared from at least one cereal flour.

In this context, the cereal may be a gluten-free cereal or a gluten-containing cereal. For example, the gluten-free cereal flour is at least one flour of a component of the group consisting of maize, rice and millet.

The gluten-containing cereal flour can be at least one flour of a component of the group consisting of wheat, spelt, rye, barley or triticale. The use of rye flour and/or wheat flour is preferred, the latter especially preferably including a protein which has been enriched as the result of protein shifting. The use of these gluten-containing cereals is advantageous because the gluten in the cereal flour is capable of sealing the cellulosic substance in an air-tight manner, which dispenses with odour-binding additions. This circumstance can be attributed to the fact that gluten retains the undesirable odour in the cellulosic substance which has been wetted by animal urine by forming a three-dimensional structure and does not allow the undesirable odour to escape into the ambient air. The binding of odours may, however, also be made possible by pentosans (mucilaginous substances), as is the case for example in rye. While rye belongs to the gluten-containing cereals, the binding of odours by pentosans predominates.

If the binding of odours is not achieved by gluten or pentosans, it may be ensured by swelling starch. This applies in particular to gluten-free cereal flour.

The cereal flour accounts for 10 to 70% by weight, preferably 20 to 65% by weight, especially preferably 30 to 60% by weight of the litter. The amount to be employed depends on how pronounced the odour-binding effect and the cluster-forming effect in the litter is intended to be. The more cereal flour present in the litter, the better the upper portions which are wetted with urine can be removed as sheet-like or clod-like clusters, and the better the odour-binding capacity. The limit is a result of the desired quality and the desired price of the litter. If cereal flour accounts for less than 10% by weight, the odour-binding capacity is insufficient. If, in contrast, the cereal flour exceeds 70% by weight, sufficient urine uptake of the litter cannot be ensured. Moreover, if the cereal flour accounts for 70% by weight or more, it favours a disadvantageous dough formation of the clusters, and, as a result, the animals can show dough residues in their coats.

The gel former accounts for 0.1 to 4% by weight, preferably 0.5 to 3.5% by weight, especially preferably 1 to 3% by weight, more preferably 1.5 to 2.5% by weight of the litter. Surprisingly, even small amounts of 0.1% by weight of gel former markedly improve the properties of a litter which only contains the cellulosic substance and cereal flour as further components.

The cereal flour within the meaning of the present invention as untreated cereal flour is not a gel former within the scope of the present invention. In order to make a cereal flour into a gel former, a considerable amount of process engineering is required. Hence, the amount of gel former of 0.1 to 4% by weight does not include the cereal flour which is mandatory in the inventive litter.

As a result of the combination of cellulosic substance, cereal flour and gel formers, the cluster stability, the binding of moisture, the reduction of odours, the formation of a smeary film (i.e. the trickling of the fluid onto the bottom of the container filled with the litter) and the economicity of the litter are improved. However, an amount of more than 4% by weight of gel former in the litter favours the sticking of the litter to animal hairs.

Within the scope of the present invention, the gel former is preferably selected from at least one component of the group consisting of modified starch, guaran, carob gum, tara gum, xanthan gum, gellan gum, gum karaya, alginate, agar, carrageenan, gum arabic, pectin, tragacanth and cellulose ether. As a result of the use of gel formers, the cluster formation can be improved and the uptake of moisture increased. Carob gum is particularly preferred.

In a preferred embodiment, the litter consists of 51 to 65% by weight of cellulosic substance, in particular bran, 31 to 45% by weight of cereal flour and 0.1 to 4% by weight, in particular 1 to 3% by weight, of carob gum.

According to a further embodiment, the litter is present as compressed granules. The compressed granules are preferably virtually non-abrading. The term “non-abrading” used here means that as far as possible no particles become detached from the granules formed, so that the development of dust can be suppressed. Compressed granules which are non-abrading are advantageous since the litter does not adhere to the animal's coat and is not carried around in the animal keeper's dwellings, as would be the case for a pulverulent litter. The compressed granules which are non-abrading can be obtained with the aid of the processes used in the prior art, as described in DE 37 32 807 A1 for example.

The granules preferably consist of granule particles of which at least 90%, especially preferably at least 95%, have a size of from 2 to 6 mm, especially preferably from 3 to 5 mm, and a ratio between the biggest and the smallest granule particles amounts to less than 5:1, preferably less than 4:1. The above-described consistency of the granule particles prevents the granule particles from being carried around by the animal.

The starting composition of the litter, consisting of 10 to 80% by weight of cellulosic substance, 10 to 70% by weight of cereal flour and 0.1 to 4% by weight of gel former, may for example be compressed, for example extruded, to give shaped articles which can be used directly when they take the form for example of small pellets with a diameter of 5 to 8 mm and a length of approximately 10 to 15 mm and which are comminuted after the compressing process by mechanical treatment such as cutting, shattering or crushing to give the granule particles. The comminution process is followed by a screening process, which is intended to eliminate from the granules unduly small and light components which have originated in the comminution process.

According to a further embodiment, the bulk density of the litter amounts to 200 to 800 g/l, preferably 250 to 750 g/l and especially preferably 450 to 550 g/l.

The inventive litter for use in animal keeping is advantageous because it is biodegradable, consists of renewable raw materials, makes possible the formation of clusters with a high cluster stability and causes little agglutination on animal hairs.

Methods

Bulk Density

The bulk density is determined in accordance with EN ISO 60 (DIN 53468). To this end, the litter is filled into a graduated cylinder with a volume of one litre. The bulk density is calculated from the quotient of mass and volume.

Economicity

Six litres of the litter are filled into a container up to a height of eight centimetres (cm). In this container, 50 millilitres (ml) of demineralized water are applied to the litter as a weak stream at five locations, using a pipette. After 30 minutes (min), the clustered litter is removed with the aid of a straining scoop, and its weight is determined. The weight of the water applied (250 ml) is deducted from this value, and the clustered volume is calculated with the aid of the bulk density. In this context, the following applies: the lower the value of the volume, the more economic the litter.

Water Absorption

Litter in an amount corresponding to a volume of 200 ml is weighed into a damp sieve of mesh size 250 micrometres (60 mesh) which has been allowed to drain and placed into a bowl with demineralized water so that all of the litter is covered. After 20 min, the sieve is removed, allowed to drain for 20 min and then weighed. The water absorption is calculated by differential weighing of the litter before and after this experiment. In this context, the following applies: the higher the value of the difference, the higher the water absorption.

Formation of a Smeary Film

Representative samples of the litter are filled to a height of 7 cm into cylindrical beakers of volume 600 ml. This corresponds to a bulk volume of 450 ml. A weak stream of demineralized water is placed from a height of 10 cm on the centre of the product bed (litter) using a 50-ml pipette (if appropriate with repeated refilling) until water appears on the bottom of the vessel (formation of a smeary film). The water volume applied until it shows through is recorded. In this context, the following applies: the higher the water volume used until it shows through, the less the tendency to form a smeary film.

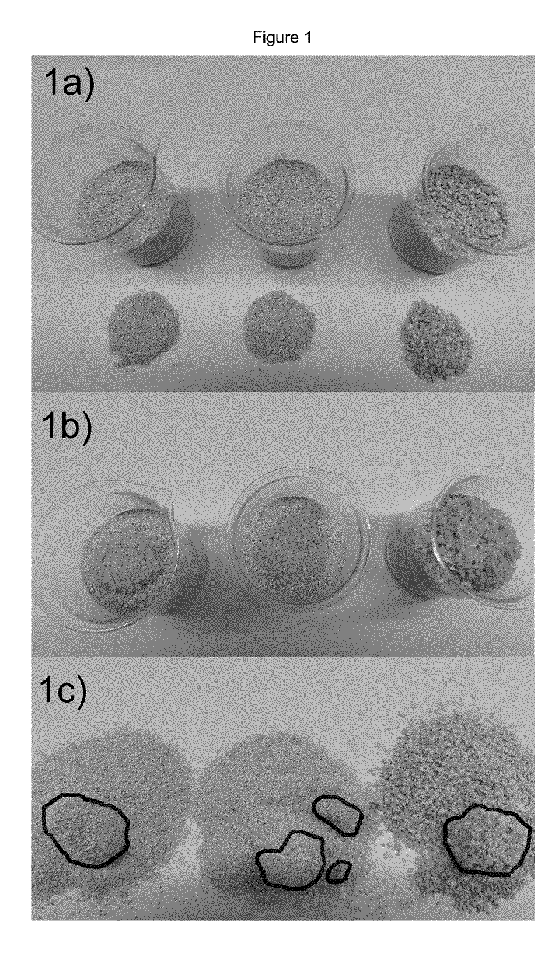

Cluster Formation The method for determining the cluster formation of the litter is shown in FIG. 1. 300-400 millilitres (ml) of litter is applied into a 500 millilitre (ml) glass beaker (FIG. 1a)), and 20 millilitres (ml) of demineralized water are applied, by means of a pipette, to the litter so that the litter in the glass beaker forms clusters (FIG. 1b)). The clustered litter is obtained by shaking the litter from the glass beaker (FIG. 1c)). In this context, the following applies: the more solid and smaller the clusters, the better the quality of the litter.

Cluster Stability

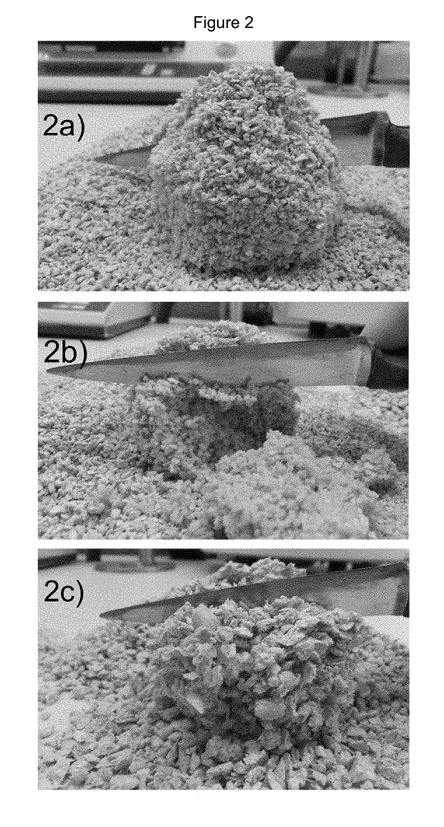

A cluster with a height of approximately 5 to 6 cm of the economicity sample (see above) is placed onto a metal sheet with its longitudinal axis facing upwards. A broad knife with a spine width 3 mm wide is now pressed with the spine against the cluster until the cluster disintegrates. After the cluster had disintegrated, the spine's penetration depth into the cluster is determined. The distance of the first contact point of the knife and the cluster before disintegration to the knife's penetration depth at the point in time of disintegration (see FIG. 2) is measured with an auxiliary device. This distance in mm (mathematically rounded up or down) is the cluster stability. In this context, the following applies: the greater the distance, the higher the cluster stability.

Tackiness

Six litres of the litter are filled into a container to a height of eight centimetres (cm). 50 millilitres (ml) of demineralized water are applied to the litter in this container as a weak stream at five locations, using a pipette. After 30 minutes (min), the clustered litter is removed with the aid of a straining scoop and its tackiness is assessed subjectively with the aid of a scale from 1 to 6. A pronounced tackiness is assessed with a mark of 6 (=very bad), and low tackiness is assessed with a mark of 1 (=very good). The average is formed from the evaluations by four testers.

The Figures Show:

FIG. 1 shows an experiment on the litter's cluster formation; in FIGS. 1a) to 1c): on the left: example 3, in the middle: comparative example 1, on the right: reference example 1; FIG. 1a) litter before the experiment; FIG. 1b) litter after the addition of water; FIG. 1c) top view of the clustered litter, the drawn-in margin of the clustered litter is shown.

FIG. 2 shows the penetration depth of a knife's spine into the clustered litter; FIG. 2a) example 3; FIG. 2b) comparative example 1; FIG. 2c) reference example 1.

The examples which follow are intended to further illustrate the present invention without being limited thereto.

### EXAMPLE 1

A mixture of 49.8% by weight of wood meal, 10% by weight of wheat bran, 20% by weight of wheat flour, 20% by weight of rye flour and 0.2% by weight of of guar gum was compacted by means of a pellet press (by Salmatec) to give pellets which were subsequently comminuted by means of a granulating shredder (by Pallmann). The litter was obtained by screening as a fraction with a size of from 2 to 4 mm and subsequently dedusted.

### EXAMPLE 2

The litter of example 2 was prepared like the litter of example 1, except that the mixing ratio of the components was altered as follows: 49% by weight of wood meal, 10% by weight of wheat bran, 20% by weight of wheat flour, 20% by weight of rye flour and 1% by weight of guar gum.

### EXAMPLE 3

The litter of example 3 was prepared like the litter of example 1, except that the mixing ratio of the components was altered as follows: 48% by weight of wood meal, 10% by weight of wheat bran, 20% by weight of wheat flour, 20% by weight of rye flour and 2% by weight of guar gum.

### EXAMPLE 4

The litter of example 4 was prepared like the litter of example 1, except that the mixing ratio of the components was altered as follows: 46% by weight of wood meal, 10% by weight of wheat bran, 20% by weight of wheat flour, 20% by weight of rye flour and 4% by weight of guar gum.

### COMPARATIVE EXAMPLE 1

The litter of comparative example 1 was prepared like the litter of example 1, except that the mixing ratio of the components was altered as follows: 50% by weight of wood meal, 10% by weight of wheat bran, 20% by weight of wheat flour and 20% by weight of rye flour.

### COMPARATIVE EXAMPLE 2

The litter of comparative example 2 was prepared like the litter of example 1, except that the mixing ratio of the components was altered as follows: 44% by weight of wood meal, 10% by weight of wheat bran, 20% by weight of wheat flour, 20% by weight of rye flour and 6% by weight of guar gum.

### REFERENCE EXAMPLE 1

The litter “CAT′S BEST ÖkoPlus” by JRS was used as the reference example.

TABLE 1

| | Wood meal/ | | Gel former |
|---|---|---|---|
| | bran | Cereal flour | (% by |
| Litter | (% by weight) | (% by weight) | weight) |
| Example 1 | 59.9 | 39.9 | 0.2 |
| Example 2 | 59.5 | 39.5 | 1 |
| Example 3 | 59 | 39 | 2 |
| Example 4 | 58 | 38 | 4 |
| Comparative example 1 | 60 | 40 | — |
| Comparative example 2 | 57 | 37 | 6 |
| Reference example 1 | 88 | — | 12 |

TABLE 2

| | Bulk density | Water absorption | Economicity |
|---|---|---|---|
| Litter | (g/l) | (%) | (ml) |
| Example 1 | 532 | 345 | 382 |
| Example 2 | 499 | 432 | 328 |
| Example 3 | 522 | 540 | 291 |
| Example 4 | 512 | 690 | 261 |
| Comparative example 1 | 505 | 330 | 392 |
| Comparative example 2 | 523 | 815 | 240 |
| Reference example 1 | 557 | 880 | 388 |

TABLE 3

| | Formation of | Cluster stability | Tackiness |
|---|---|---|---|
| Litter | smeary film (ml) | (mm) | (Mark) |
| Example 1 | 140 | 8 | 1 |
| Example 2 | 220 | 18 | 2 |
| Example 3 | >300 | 25 | 2 |
| Example 4 | >300 | 26 | 3 |
| Comparative example 1 | 120 | 5 | 1 |
| Comparative example 2 | >300 | 28 | 4 |
| Reference example 1 | 18 | 9 | 3 |

Tables 2 and 3 demonstrate the advantageous properties of the inventive litter. Examples 1 to 4 show an advantageous economicity and formation of smeary film, an increased cluster stability combined with a low tackiness. Comparative example 2, while consisting of a combination of wood meal/bran, cereal flour and gel former, shows a disadvantageously more pronounced tackiness which can be attributed to the fact that the amount of gel former is increased in comparison with the inventive litter. Reference example 1, again, shows a higher tackiness than examples 1 to 3. This increased tackiness of reference example 1 is caused by the high amount of gel former, which amounts to 12% by weight. By addition of cereal flour to the litter it is possible to reduce the tackiness, as demonstrated in particular for examples 1 to 3 in table 3. Furthermore, only coarsely-particulate wood meal granules can be used in the litter of reference example 1 due to the high amount of gel former, which amounts to 12% by weight. As a result, clustered litter can only be removed from the container with difficulty by screening.

FIG. 1 shows the advantageous cluster-forming property of the inventive litter (example 3, FIG. 1: on the left) in comparison with comparative example 1 (FIG. 1: in the middle) and reference example 1 (FIG. 1: on the right). The inventive litter formed a compact solid cluster in this experiment, while the litter of comparative example 1 formed three clusters and must therefore be assessed as being disadvantageous in respect of cluster formation. The clustered litter of reference example 1 was less compact and less solid in comparison with the clustered litter of example 3. Owing to this fact, the cluster of reference example 1 can disintegrate very readily when removing the cluster from the used litter, and the granule residues which readily become detached can soil the remaining litter which has not taken up any fluid, so that the remaining litter becomes odorous more rapidly and must be changed sooner.

The low cluster stability of comparative example 1 and of reference example 1 in comparison with the inventive litter of example 3 is shown in FIG. 2. Example 3 (FIG. 2a)) shows a clearly greater penetration depth of the spine into the clustered litter in comparison with comparative example 1 (FIG. 2b)) and reference example 1 (FIG. 2c)), and therefore has a higher cluster stability than the litter of comparative example 1 and reference example 1. The cluster stability of the litter of comparative example 1 was so low that the cluster disintegrated into two parts. The improved cluster stability of the litter of example 3 in comparison with the litter of comparative example 1 and reference example 1 can be attributed to the fact that only the litter of example 3 contained the advantageous combination of cereal flour and gel former.

FIG. 2a) also makes clear the abovementioned compactness of the cluster of example 3. The coarsely-particulate structure of the clustered litter of reference example 1, in contrast, is shown in FIG. 2c). The particles of this coarsely-particulate cluster can readily become detached from the latter and therefore soil the remaining litter which has not yet taken up any fluid, so that the litter becomes odorous more rapidly and must accordingly be exchanged sooner.

1. Litter for use in animal keeping, consisting of 10 to 80% by weight of cellulosic substance which is selected from at least one component of the group consisting of wood meal, bran, hulls and bran, cereal hull and cereal husk, 10 to 70% by weight of cereal flour and 0.1 to 4% by weight of gel former, based on the total weight of the litter, where the above components always amount to 100% by weight, where the cellulosic substance is present in the form of particles with a particle size of from 0.2 to 6 mm.

2. Litter according to claim 1, wherein the cellulosic substance is bran.

3. Litter according to claim 1, wherein the gel former is selected from at least one component of the group consisting of modified starch, guaran, carob gum, tara gum, xanthan gum, gellan gum, gum karaya, alginate, agar, carrageenan, gum arabic, pectin, tragacanth and cellulose ether.

4. Litter according to one of claim 1, wherein the gel former is carob gum.

5. Litter according to claim 1, wherein the cereal flour is at least one flour of a component of the group consisting of wheat, spelt, rye, barleys or triticale.

6. Litter according to claim 1, consisting of 51 to 65% by weight of bran, 31 to 45% by weight of cereal flour and 0.1 to 4% by weight of carob gum.

7. Litter according to claim 1, wherein the cereal flour is a pre-gelatinized flour of a cereal.

8. Litter according to claim 1, wherein the litter is present as compressed granules.

9. Litter according to claim 1, wherein the bulk density of the litter amounts to 200 to 800 g/l.
